(19) United States
(12) Patent Application Publication
(10) Pub. No.: US 2011/0312339 A1
(43) Pub. Date: Dec. 22, 2011

(54) Methods and Arrangements in a Wireless Communication System

(75) Inventors: Tarmo Kuningas, Sollentuna (SE); Elena Voltolna, Jarfalla (SE); Dirk Gerstenberger, Stockholm (SE); Daniel Larsson, Solna (SE)

(73) Assignee: TELEFONAKTIEBOLAGET L M ERICSSON (PUBL), Stockholm (SE)

(21) Appl. No.: 13/148,312

(22) PCT Filed: Feb. 26, 2010
(86) PCT No.: PCT/SE10/50227

§ 371 Date: Aug. 6, 2011

Related U.S. Application Data
(60) Provisional application No. 61/158,476, filed on Mar. 9, 2009.

(51) Int. Cl. H04W 24/00

(52) U.S. Cl. 455/456.1

(57) ABSTRACT

The present invention relates to methods and arrangements in a network node such as a positioning server and a user equipment of enabling downlink-based positioning of the user equipment which is served by a serving cell. The network node estimates (210) a timing difference between a timing of a neighboring cell and a timing of the serving cell. This is done based on synchronization information associated with the neighboring and serving cells. It then transmits (220) an instruction to perform a positioning measurement to the user equipment. The instruction comprises an identity of the neighboring cell and the estimated timing difference. In this way the UE may find the reference signal when performing the positioning measurements, even when the SFNs of the neighbor cell is not aligned with the SFN of the serving cell.

### TECHNICAL FIELD

The present invention relates to methods and arrangements in a wireless communication system, in particular to methods and arrangements for facilitating positioning of User Equipments, e.g. in an e-UTRAN.

### BACKGROUND

The Universal Mobile Telecommunication System (UMTS) is one of the third generation mobile communication technologies designed to succeed GSM. 3GPP Long Term Evolution (LTE) is a project within the 3^{rd} Generation Partnership Project (3GPP) to improve the UMTS standard to cope with future requirements in terms of improved services such as higher data rates, improved efficiency, lowered costs etc. The Universal Terrestrial Radio Access Network (UTRAN) is the radio access network of a UMTS system and evolved UTRAN (e-UTRAN) is the radio access network of an LTE system. As illustrated in FIG. 1, an e-UTRAN typically comprises user equipments (UE) 150 wirelessly connected to radio base stations (RBS) 110a-c, commonly referred to as eNodeB. The eNodeB serves one or more areas referred to as cells 120a-c. In FIG. 1 the UE 150 is served by the serving cell 120a. Cells 120b and 120c are neighboring cells.

Mobile user positioning is the process of determining UE coordinates in space. Once the coordinates are available, the position can be mapped to a certain place or location. The mapping function and the delivery of the location information on request are parts of the location service which is required for the basic emergency services. Services that further exploit the location knowledge or that are based on location knowledge to offer customers some additional value are referred to as location-aware and location-based services, respectively.

There exist a variety of positioning techniques in wireless communications networks, differing in their accuracy, implementation cost, complexity, applicability in different environments, etc. In existing networks, the most common ones are UE assisted solutions where a serving mobile location center (SMLC in GSM and UMTS, enhanced SMLC, eSMLC, in LTE) calculates the UE position based on measurements reported by the UE. The SMLC/eSMLC 100 is either a separate network node (as illustrated in FIG. 1) or an integrated functionality in some other network node. Among such methods, Assisted Global Positioning System (A-GPS) typically provides the best accuracy. Combining the mobile technology and GPS, A-GPS enhances the UE receiver sensitivity by providing orbit and other data to the UE. Drawbacks of A-GPS are that a GPS-equipped UE is required, and that it doesn't function in certain environments such as tunnels, indoor areas and dense urban areas. Therefore other complementing methods for positioning are needed. These methods use UE measurements of the time difference of arrival (TDOA) of signals from different cellular antennas.

The technique currently adopted for UMTS and LTE for downlink-based positioning is Observed TDOA (OTDOA). OTDOA is a multi-lateration technique estimating TDOA of signals received from three or more sites (see FIG. 1). To enable positioning, the UE should be able to detect positioning reference signals from at least three geographically dispersed RBS. This implies that the reference signals need to have high enough signal-to-interference ratios (SINR) in order for the UE to be able to detect them.

In the definition of positioning methods for UEs in e-UTRAN, the discussions have concentrated on synchronized networks, i.e. networks where the System Frame Number (SFN) timing in every cell in the network is phase aligned. Although synchronized networks with perfectly aligned SFN timing throughout the network may simplify the UE positioning methods, there are other network synchronization deployment cases. Some examples are:
Phase locked networks with a known phase error range. The SFN timing in every cell is intended to be phase aligned, but is in practice limited by a known phase error range. The phase error range may be covered by requirements as e.g. defined for LTE TDD base stations in the 3GPP specification 36.104.
Phase locked networks where the SFN timing differs between cells in a known way (at least in the concerned area). The phase offsets of the cells, defined as the difference between the SFN of the cell and the Base station Frame Number (BFN) of the controlling eNB, are different. Cells in such a phase locked network may also have a known phase error range in addition to the phase offset.
Unsynchronized networks where the SFN timing in every cell of the network is unknown. Moreover, the SFN timing in each cell may have considerable phase drift as the respective eNBs are only frequency synchronized.

In these different examples of network synchronization deployment cases, the UE cannot know in beforehand exactly when the positioning reference signal is transmitted, and must therefore blindly detect the positioning reference signal transmitted from the different eNBs in order to be able to do the OTDOA measurements. This makes the measurements more complex than in the case with a perfectly aligned SFN timing, and may also give a lower accuracy of the measurements as a higher level of noise is measured.

### SUMMARY

The object of the present invention is to address some of the problems and disadvantages outlined above, and to enable downlink-based positioning of a user equipment requiring less user equipment processing. This object and others are achieved by the methods and devices according to the independent claims, and by the embodiments according to the dependent claims.

In accordance with a first aspect of the present invention, a method for a network node in a wireless communications system, of enabling downlink-based positioning of a user equipment which is served by a serving cell is provided. The method comprises estimating a timing difference between a timing of a neighboring cell and a timing of the serving cell, based on synchronization information associated with the neighboring and serving cells. The method also comprises transmitting an instruction to perform a positioning measurement to the user equipment. The instruction comprises an identity of the neighboring cell and the estimated timing difference.

In accordance with a second aspect of the present invention, a method for a user equipment in a wireless communications system, of enabling downlink-based positioning of the user equipment which is served by a serving cell is provided. The method comprises receiving an instruction to perform a positioning measurement from a network node. The instruction comprises an identity of a neighboring cell and an estimated timing difference between a timing of the neighboring cell and a timing of the serving cell. The method also comprises using the estimated timing difference when performing the positioning measurement of a reference signal of the neighboring cell according to the received instruction.

In accordance with a third aspect of the present invention, a network node configured to enable downlink-based positioning of a user equipment which is served by a serving cell in a wireless communications system is provided. The network node comprises an estimating unit configured to estimate a timing difference between a timing of a neighboring cell and a timing of the serving cell, based on synchronization information associated with the neighboring and serving cells. It also comprises a transmitter configured to transmit an instruction to perform a positioning measurement to the user equipment, the instruction comprising an identity of the neighboring cell and the estimated timing difference.

In accordance with a fourth aspect of the present invention, a user equipment configured to enable downlink-based positioning of the user equipment served by a serving cell in a wireless communications system is provided. The user equipment comprises a receiver configured to receive an instruction to perform a positioning measurement from a network node. The instruction comprises an identity of a neighboring cell and an estimated timing difference between a timing of the neighboring cell and a timing of the serving cell. The user equipment also comprises a positioning measurement unit configured to use the estimated timing difference when performing the positioning measurement of a reference signal of the neighboring cell according to the received instruction.

An advantage of embodiments of the present invention is that they allow supporting positioning in networks with different levels of synchronization.

Still another advantage of embodiments of the present invention is that the user equipment needs less processing when performing positioning measurements as they will not need to search blindly for the positioning reference signals to measure on, which allows for a reduced user equipment complexity.

A further advantage of embodiments of the present invention is that the positioning measurements may be more accurate when the UE do not need to search blindly for the reference signal as there will be less noise when measuring.

Other objects, advantages and novel features of the invention will become apparent from the following detailed description of the invention when considered in conjunction with the accompanying drawings.

### BRIEF DESCRIPTION OF THE DRAWINGS

FIG. 1 illustrates schematically a part of a conventional LTE system wherein the present invention may be implemented.

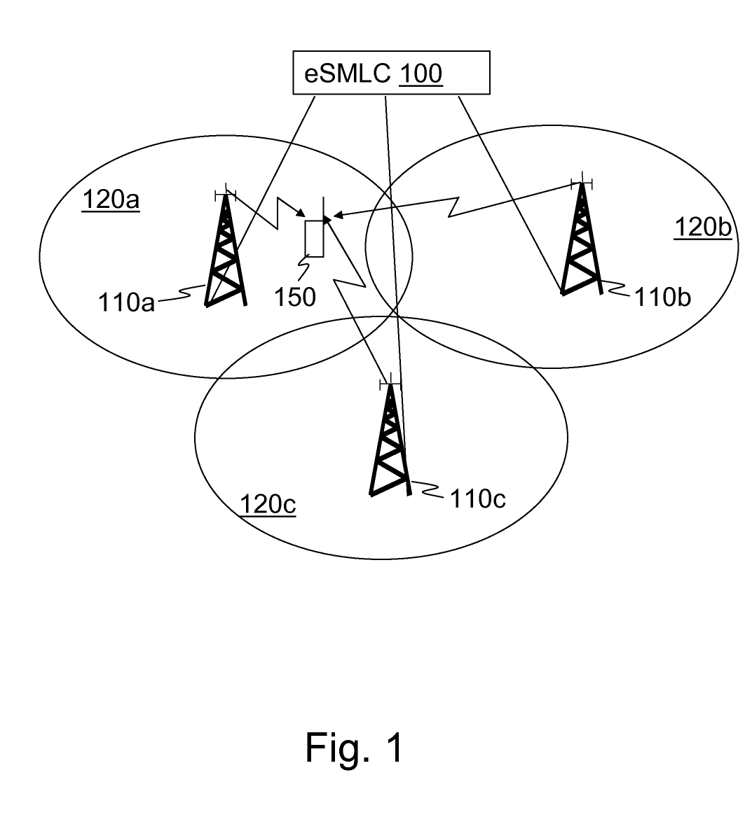

FIGS. 2a-c are flowcharts of the method in the network node according to embodiments of the present invention.

FIG. 3 is a flowchart of the method in the UE according to embodiments of the present invention.

FIG. 4 illustrates schematically the network node and the UE according to embodiments of the present invention.

### DETAILED DESCRIPTION

In the following, the invention will be described in more detail with reference to certain embodiments and to accompanying drawings. For purposes of explanation and not limitation, specific details are set forth, such as particular scenarios, techniques, etc., in order to provide a thorough understanding of the present invention. However, it will be apparent to one skilled in the art that the present invention may be practiced in other embodiments that depart from these specific details.

Moreover, those skilled in the art will appreciate that the functions and means explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as in a system comprising a computer processor and a memory coupled to the processor, wherein the memory is encoded with one or more programs that may perform the functions disclosed herein.

The present invention is described herein by way of reference to particular example scenarios. In particular embodiments of the invention are described in a non-limiting general context in relation to an e-UTRAN, with a centralized positioning server eSMLC communicating with the UEs via the eNBs. Furthermore, embodiments of the invention are described in a non-limiting way in relation to OTDOA as the chosen downlink-based positioning method. It should though be noted that the invention and its exemplary embodiments may also be applied to other types of radio access networks such as UTRAN and WiMax, and to other positioning methods and solutions.

In embodiments of the present invention, the drawbacks related to the UE having to search blindly for a positioning reference signal when performing UE positioning measurements, are addressed by a solution wherein a network node such as a dedicated eSMLC estimates a timing difference between the timing of the neighboring cell and the timing of the serving cell based on synchronization information for the cells. The timing of a cell refers to the SFN timing as described above. The estimated timing difference is then transmitted to the UE, which may then use this timing difference when performing the positioning measurements in order to figure out when to measure the reference signal.

The network node or the eSMLC is configured with relevant and up-to-date cell synchronization information. Cell synchronization information comprises e.g.:
The synchronization type, i.e. frequency synchronization, or phase synchronization (if a cell is phase synchronized it is also considered to fulfill the frequency synchronization requirements).
The time base—Global Navigation Satellite System Time (e.g. GPS time), International Atomic Time, etc.
The System Frame Number (SFN) initialization time.
The phase offset, i.e. the difference between the SFN of the cell and the Base station Frame Number (BFN) of the controlling eNB (where the phase offset is 0 in all cells in case of a synchronized network with aligned SFN timing).
The phase accuracy, as e.g. defined for LTE TDD (Time Division Duplex) base stations in the standard.
A phase drift indication identifying the reliability of provided phase information. This parameter may be relevant in unsynchronized networks and corresponds to the phase drift of the eNB internal clock.
The frequency error of the eNB internal clock, which may also be relevant in unsynchronized networks.

According to embodiments of the present invention, the eSMLC may use such cell synchronization information to estimate a timing difference between a neighbor cell timing and a serving cell timing for each of the neighbor cells that the UE may detect positioning reference signals from. This estimated timing difference is transmitted to the UE via the eNB, when the UE receives instructions to perform a positioning measurement. The estimated timing difference is comprised in the instructions together with the identity of the corresponding neighbor cell.

The result from the UEs positioning measurements, i.e. from the measurement of the observed time difference of arrival of a positioning reference signal for a number of neighboring cells, is reported back to the eSMLC that instructed the UE to do the positioning measurements. The eSMLC may then, based on the reported positioning measurement result as well as based on e.g. cell synchronization information and antenna location information, calculate the position of the UE that performed the measurements. The antenna location information is of interest as the antenna may be placed at a distance from the eNB in some cases.

The estimation of the timing difference, performed by the eSMLC, may be done in different ways depending on the synchronization type of the cells. In a first embodiment of the present invention, the cells are phase synchronized. The estimated relative cell timing or timing difference is calculated based on the cell synchronization information according to the following. All calculations are done in the same units (e.g. micro seconds).

relative_time(cell_{—}N)=[time_base_dif+init_time_dif+phase_offset_dif]MOD length(slot)

where:
relative_time(cell_N) is the timing difference between the timing of the neighbor cell_N and the timing of the serving cell.
time_base_dif is the difference between the accumulated leap seconds included in the used time base of the eNB controlling the neighbor cell_N and the accumulated leap seconds included in the used time base of the eNB controlling the serving cell.
init_time_dif is the difference between the BFN initialization time of the eNB controlling the neighbor cell_N and the BFN initialization time of the eNB controlling the serving cell.
phase_offset_dif is the difference between the phase offset of the neighbor cell_N and the phase offset of the serving cell.
length(slot) is the length of the slot in a standardized e-UTRA frame structure.

The estimated timing difference calculated according to the above described first embodiment may also optionally be adjusted with a relative accuracy which is the product of the phase accuracy of the neighbor cell_N and the phase accuracy of the serving cell.

In a second embodiment of the present invention, the cells are frequency synchronized only (also referred to as unsynchronized), and the cell synchronization information is complemented with previous UE measurements to estimate a timing difference and thereby define more accurate instructions for positioning measurements for the UE.

In this second embodiment, the eSMLC has via the serving eNB been able to collect phase difference measurements of the neighboring cell timing from the UEs that have been previously positioned. The timing difference between the timing of a neighbor cell_N and the serving cell of a UE, may thus be estimated as a statistical value of the previous measurement results for cell_N provided by the previously positioned UEs. This statistically estimated timing difference may then also be further adjusted with e.g. the phase drift and the frequency error of the cell_N further described above.

In a scenario with a frequency synchronized network where a statistical estimation of the timing difference may not be determined as the eSMLC has not been able to collect phase difference measurements relative to neighboring cells, the eSMLC may alternatively request the UE to perform full cell search and the respective SFN-SFN phase difference measurements.

The UE that receives an instruction to perform a positioning measurement, where the instruction comprises the neighbor cell identities and the corresponding estimated timing difference or relative cell timing, will be able to use the estimated timing difference to find the positioning reference signal from the corresponding neighbor cell. The timing difference will serve as a timing assistance for the UE, as it may deduce when in time it can expect to receive the reference signal that it will measure. This will thus simplify the signal processing in the UE and will also allow for a more accurate measurement of the reference signal.

The timing of a cell may either be the timing of the frame when received at the UE, referred to as the receive timing of the cell, or it may be the timing of the frame when transmitted to the UE, referred to as the transmit timing. Basing the estimation of the timing difference on the receive timing may be more accurate for the UE to determine where to find the positioning reference signal. However, when the cells are small the receive timing is approximately the same as the transmit timing, making it possible to base the estimation of the timing difference on the transmit timing instead.

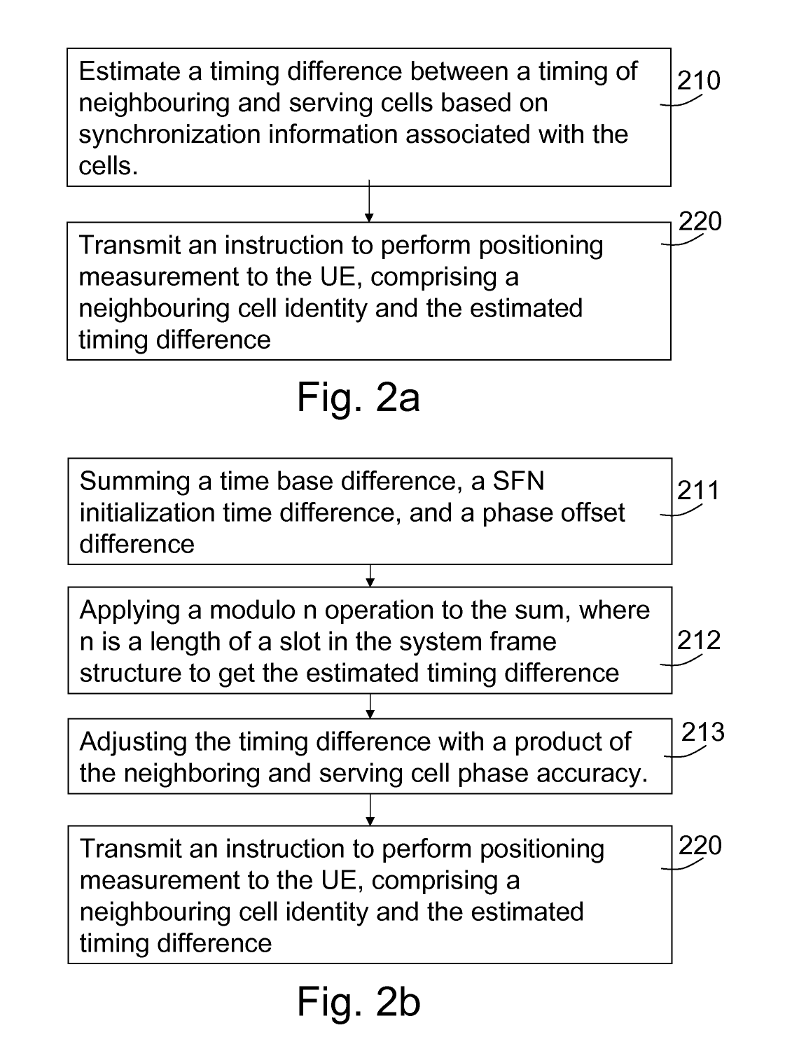

FIG. 2a is a flowchart of the method in the network node according to one embodiment of the present invention. The network node may in one embodiment be an eSMLC in an LTE system, communicating with the UE via the eNB. The method illustrated in the flowchart comprises the following steps:
210: The timing difference (or the relative cell timing) between the timing of a neighboring cell and the serving cell is estimated by the network node. This is done on the basis of cell synchronization information that is configured in the network. In one embodiment, the cell synchronization information comprises at least one of the time base used in the cell, the SFN initialization time of the cell, and the phase offset for the cell, further described above.
220: The network node then transmits an instruction to perform positioning measurements to the UE. The instruction comprises a neighbor cell identity or a list of neighbor cell identities to measure on, and for each neighbor cell identity the corresponding estimated timing difference.

FIG. 2b is a flowchart of the method in the network node according to the first embodiment of the present invention described above. In this first embodiment, the cells are phase synchronized and the step 210 of estimating the timing difference between the neighboring cell and the serving cell comprises the two following calculation:
211: Sum the time base difference, the SFN initialization time difference, and the phase offset difference between the two cells. The cell synchronization information is thus used to estimate the timing difference between the cells.
212: Apply a modulo n operation to the resulting sum (in 211), where n is the length of a slot in the system frame structure. The modulo operation results in the remainder of division of the timing difference between the cells by the slot length. Positioning reference signals from different cells are transmitted so that they will differ less than one slot as seen by the UE. The modulo operation will thus give an estimation of where to look for the positioning reference signal within a time slot.

Optionally, also the phase accuracy may be taken into account by adjusting 213 the timing difference with the product of the relevant neighboring cell accuracy and the serving cell accuracy. The timing difference estimated according to steps 211, 212 and optionally also 213, is then comprised in the instruction transmitted 220 as described above with reference to FIG. 2a.

FIG. 2c is a flowchart of the method in the network node according to the second embodiment of the present invention described above. In this embodiment the cells are frequency synchronized but not phase synchronized, and in order to be able to estimate the timing difference, the network node will rely on phase difference measurements performed by previously positioned UEs. The step 210 described above will therefore comprise a compilation 214 of a statistical timing difference such as an average value of the timing difference calculated based on the phase difference measurements relative to a neighbor cell, performed by previously positioned UEs. Step 220 is performed as described above.

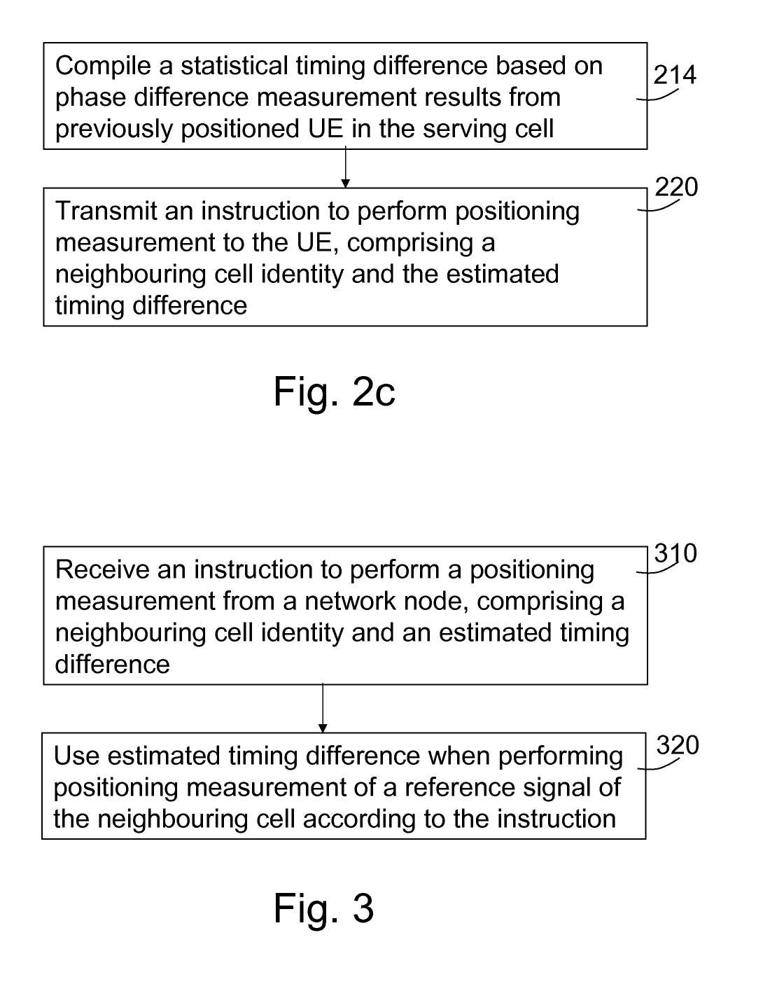

FIG. 3 is a flowchart of the method in the UE according to one embodiment of the present invention. The UE is served by a serving cell in a wireless communication system which may e.g. be an LTE system. The UE uses downlink-based positioning such as OTDOA. The method comprises the following steps:
310: Receive an instruction to perform a positioning measurement. The instruction is received from a network node, via the eNB. The instruction comprises a neighboring cell identity or a list of neighboring cell identities. It also comprises for each of the neighboring cell identities, the estimated timing difference between the timing of neighboring cell and the serving cell.
320: The UE uses the estimated timing difference received with the instruction in order to find the reference signal when performing the positioning measurements according to the instructions. The UE will thus not need to search blindly for the reference signal although the SFN of the neighbor cell is not aligned with the serving cell's SFN, as it has received timing assistance with the instruction.

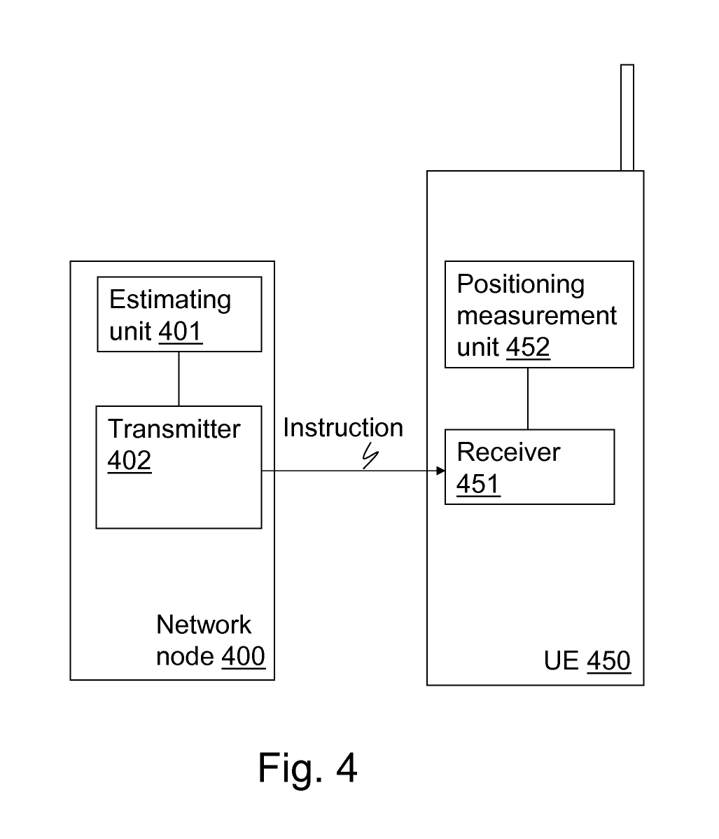

The network node 400 is schematically illustrated in FIG. 4, according to embodiments of the present invention. The network node 400 may in one embodiment be the eSMLC in an LTE system, supporting positioning with the OTDOA technique. It comprises an estimating unit 401 which is configured to estimate the timing difference between the neighboring cell timing and the serving cell timing, based on the synchronization information for the neighboring cell and the serving cell. The cell synchronization information may comprise of one or more of a time base, a SFN initialization time, and a phase offset for the cell. The network node also comprises a transmitter 402 for transmitting an instruction to perform a positioning measurement to the UE. The instruction comprises a list of neighboring cell identities to measure on as well as the estimated timing difference for each neighbor cell.

In the first embodiment described above, the estimating unit 401 is configured to estimate a timing difference by summing a time base difference, a system frame number initialization time difference, and a phase offset difference between the neighboring cell and the serving cell, and by applying a modulo n operation to the sum, wherein n is the length of a slot in the system frame structure. The estimating unit 401 may optionally be configured to adjust the estimated timing difference with the product of the phase accuracy of the neighboring and serving cells.

In the second embodiment described above, the estimating unit 401 is configured to estimate the timing difference by compiling a statistical timing difference. This statistical timing difference may e.g. be an average value of phase difference measurement results from one or more previously positioned UEs in the serving cell. The phase difference should be measured relative to the neighboring cell.

The UE 450 according to embodiments of the present invention is also illustrated in FIG. 4. The UE 450 may in one embodiment be configured to enable downlink-based positioning measurements such as OTDOA measurements in an LTE system. It comprises a receiver 451 for receiving the instruction to perform positioning measurements from the network node via the eNB. The instruction comprises identities of neighboring cells to measure on, and the estimated timing difference for each neighbor cell identity. The UE also comprises a positioning measurement unit 452 which is configured to perform the positioning measurements according to the received instruction, using the estimated timing differences.

The above mentioned and described embodiments are only given as examples and should not be limiting to the present invention. Other solutions, uses, objectives, and functions within the scope of the invention as claimed in the accompanying patent claims should be apparent for the person skilled in the art.

### ABBREVIATIONS

3GPP 3rd Generation Partnership Project
A-GPS Assisted GPS
BFN Base station Frame Number
RBS Radio Base Station
eNodeB evolved Node B
e-UTRAN evolved UTRAN
eSMLC evolved SMLC
GPS Global Positioning System
GSM Global System for Mobile communications
LTE Long-Term Evolution
OTDOA Observed TDOA
SINR Signal-to-Interference plus Noise Ratio
SMLC Serving Mobile Location Center
SFN System Frame Number
TDOA Time Difference of Arrival
UE User Equipment
UMTS Universal Mobile Telecommunications System
UTRAN Universal Terrestrial Radio Access Network

1.-20. (canceled)

21. A method for a network node in a wireless communication system of enabling downlink-based positioning of a user equipment served by a serving cell, the method comprising:
estimating a timing difference between a timing of a neighboring cell and a timing of the serving cell based on synchronization information associated with the neighboring and serving cells; and
transmitting an instruction to perform a positioning measurement to the user equipment, the instruction comprising an identity of the neighboring cell and an estimate of the timing difference.

22. The method of claim 21, wherein the synchronization information associated with the neighboring and serving cells comprises for each of the cells at least one of: a time base, a system frame number initialization time, and a phase offset.

23. The method of claim 21, wherein estimating the timing difference comprises summing a time base difference between the neighboring cell and the serving cell, a system frame number initialization time difference between the neighboring cell and the serving cell, and a phase offset difference between the neighboring cell and the serving cell; and applying a modulo n operation to the sum, where n is a length of a slot in a system frame structure.

24. The method of claim 23, wherein estimating the timing difference further comprises adjusting the timing difference based on a product of a phase accuracy of the neighboring cell and a phase accuracy of the serving cell.

25. The method of claim 21, wherein estimating the timing difference comprises compiling a statistical timing difference based on a phase difference measurement from at least one previously positioned user equipment in the serving cell; and the phase difference is relative to the neighboring cell.

26. The method of claim 21, wherein the downlink-based positioning is a positioning based on observed time difference of arrival.

27. The method of claim 21, wherein the wireless communication system is a Long Term Evolution system.

28. A method for a user equipment in a wireless communication system of enabling downlink-based positioning of the user equipment served by a serving cell, the method comprising:
receiving, in the user equipment from a network node, an instruction to perform a positioning measurement, the instruction comprising an identity of a neighboring cell and an estimated timing difference between a timing of the neighboring cell and a timing of the serving cell; and
using the estimated timing difference when performing the positioning measurement of a reference signal of the neighboring cell according to the received instruction.

29. The method of claim 28, wherein the downlink-based positioning is a positioning based on observed time difference of arrival.

30. The method of claim 28, wherein the wireless communication system is a Long Term Evolution system.

31. A network node for enabling downlink-based positioning of a user equipment served by a serving cell in a wireless communication system, the network node comprising:
an estimating unit configured to estimate a timing difference between a timing of a neighboring cell and a timing of the serving cell based on synchronization information associated with the neighboring and serving cells; and
a transmitter configured to transmit an instruction to perform a positioning measurement to the user equipment, the instruction comprising an identity of the neighboring cell and an estimate of the timing difference.

32. The network node of claim 31, wherein the synchronization information associated with the neighboring and serving cells comprises for each of the cells at least one of a time base, a system frame number initialization time, and a phase offset.

33. The network node of claim 31, wherein the estimating unit is configured to estimate the timing difference by summing a time base difference between the neighboring cell and the serving cell, a system frame number initialization time difference between the neighboring cell and the serving cell, and a phase offset difference between the neighboring cell and the serving cell; and applying a modulo n operation to the sum, where n is a length of a slot in a system frame structure.

34. The network node of claim 33, wherein the estimating unit is further configured to adjust the estimate of the timing difference based on a product of a phase accuracy of the neighboring cell and a phase accuracy of the serving cell.

35. The network node of claim 31, wherein the estimating unit is configured to estimate the timing difference by compiling a statistical timing difference based on a phase difference measurement from at least one previously positioned user equipment in the serving cell; and the phase difference is relative to the neighboring cell.

36. The network node of claim 31, wherein the downlink-based positioning is a positioning based on observed time difference of arrival.

37. The network node of claim 31, wherein the wireless communication system is a Long Term Evolution system.

38. A user equipment configured to enable downlink-based positioning of the user equipment served by a serving cell in a wireless communication system, the user equipment comprising:
a receiver configured to receive an instruction to perform a positioning measurement from a network node, the instruction comprising an identity of a neighboring cell and an estimated timing difference between a timing of the neighboring cell and a timing of the serving cell; and
a positioning measurement unit configured to use the estimated timing difference when performing the positioning measurement of a reference signal of the neighboring cell according to the instruction.

39. The user equipment of claim 38, wherein the downlink-based positioning is a positioning based on observed time difference of arrival.

40. The user equipment of claim 38, wherein the wireless communication system is a Long Term Evolution system.
